(19) United States
(12) Patent Application Publication
(10) Pub. No.: US 2004/0097396 A1
(43) Pub. Date: May 20, 2004

(54) Concentrated fabric softening composition containing esterquat with specific ester distribution and an electrolyte

(76) Inventors: Myriam Peeters, Liege (BE); Jean-Paul Grandmaire, Andrimont (BE); Doris More, Neuville-en-Condroz (BE); Nunzio Mineo, Grace-Hollogne (BE)

Correspondence Address: COLGATE-PALMOLIVE COMPANY, 909 River Road, P.O. Box 1343, Piscataway, NJ, 08855-1343, US

(21) Appl. No.: 10/294,874

(22) Filed: Nov. 14, 2002

(51) Int. Cl. C11D 1/00

(52) U.S. Cl. 510/515; 510/504

(57) ABSTRACT

An aqueous rinse cycle fabric softening composition is provided containing an esterquat softening compound which remains physically stable and which is characterized by a stable viscosity below about 500 cps such that it remains easily pourable over a wide range of ambient temperatures and for extended periods of time, which composition comprises:

(a) from about 10% to about 25% by weight, of a biodegradable fatty ester quaternary ammonium compound derived from the reaction of an alkanol amine and a fatty acid derivative followed by quaternization, said fatty ester quaternary ammonium compound being represented by the formula:

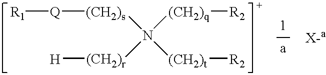

wherein Q represents a carboxyl group having the structure —OCO— or —COO—; R1 represents an aliphatic hydrocarbon group having from 8 to 22 carbon atoms; R2 represents —Q-R1 or —OH; q, r, s and t, each independently represent a number of from 1 to 3; and X^{-a} is an anion of valence a; and

wherein the normalized percentage of monoester compound in said fatty ester quaternary ammonium compound is from 28% to 39%; the normalized percentage of diester compound is from 52% to 62% and the normalized percentage of triester compound is from 7% to 14%; all percentages being by weight; and

(b) from about 0.01% to about 1%, by weight, of an electrolyte.

### FIELD OF THE INVENTION

This invention relates to liquid fabric softening compositions. More particularly, this invention relates to fabric softening compositions which are suitable for use in the rinse cycle of an automatic home washing machine and which remain stable and pourable over extended periods of time.

### BACKGROUND OF THE INVENTION

Esterified quaternary ammonium compounds are well known in the art as fabric softeners. U.S. Pat. No. 4,844,823 to Jacques et al. describes a diesterified long chain fatty acid di-lower alkyl quaternary ammonium salt as a preferred class of cationic softener for use in conjunction with a fatty alcohol. In EP-A-309052, there is disclosed a liquid softening composition containing a monoester or diester quaternary ammonium compound in combination with an alkyoxylated alcohol which is said to improve the chemical stability of the quaternized softening compound.

Esterified quaternary ammonium compounds (“Esterquats”) are described in U.S. Pat. No. 3,915,867 to Kang et al. (Stepan) which comprise N-methyl, N,N-di-(beta-C₁₄-C₁₈-acyloxy ethyl),N-beta-hydroxy ethyl ammonium metho sulfate. These esterquats are characterized by good softening properties and excellent whiteness retention and rewetting properties, and are prepared by the reaction of an alkanol amine and a fatty acid alkyl ester mixture.

In U.S. Pat. No. 5,637,743 to Contet et al. (Stepan) a quaternary ammonium salt fabric softener is described derived from the reaction of a fatty acid or a fatty ester derivative of such acid with a tertiary amine wherein the mole ratio of the fatty acid fraction to the tertiary amine is between 1.85 to 1.40 which corresponds to an increased level of monoester in the equilibrium distribution prior to the quaternization process.

While satisfactory results are generally obtained with these prior art fabric softening compounds, further improvements are needed in terms of being able to provide efficacious fabric softening while using concentrated fabric softening compositions; softeners with higher concentrations being typically physically unstable and unpourable when subjected to temperature variations, or to extensive ageing. Accordingly, there is a need in the art for esterquat-based fabric softening compositions which remain physically stable and which are characterized by stable viscosity below about 500 cps such that it remains easily pourable over a wide range of ambient temperatures and for extended periods of time.

### SUMMARY OF THE INVENTION

The present invention provides a concentrated dispersible aqueous rinse cycle fabric softening composition which remains physically stable and which is characterized by a stable viscosity below about 500 cps such that it remains easily pourable over a wide range of ambient temperatures and for extended periods of time comprising:

(a) from about 10% to about 25% by weight, of a biodegradable fatty ester quaternary ammonium compound derived from the reaction of an alkanol amine and a fatty acid derivative followed by quaternization, said fatty ester quaternary ammonium compound being represented by the formula:

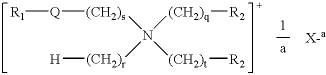

wherein Q represents a carboxyl group having the structure —OCO— or —COO—; R1 represents an aliphatic hydrocarbon group having from 8 to 22 carbon atoms; R2 represents —Q-R1 or —OH; q, r, s and t, each independently represent a number of from 1 to 3; and X^{-a} is an anion of valence a; and

wherein said fatty ester quaternary ammonium compound is comprised of a distribution of monoester, diester and triester compounds, the monoesterquat compound being formed when each R₂ is —OH; the diesterquat compound being formed when one R₂ is —OH and the other R₂ is —Q-R1; and the triesterquat compound being formed when each R₂ is —Q-R1; and wherein the normalized percentage of monoesterquat compound in said fatty ester quaternary ammonium compound is from about 28% to about 39%; the normalized percentage of diesterquat compound is from about 52% to about 62% and the normalized percentage of triesterquat compound is from about 7% to about 14%; all percentages being by weight;

(b) from about 0.01% to about 1%, by weight, of an electrolyte; and

(c) from about 0% to about 2%, by weight, of a sequestering agent;

(d) from about 0% to about 2%, by weight, of an emulsifier;

(e) from about 0% to about 5%, by weight, of a perfume; and

(f) balance water.

In a preferred embodiment of the invention, the fabric softening composition comprises about 12% to about 20%, by weight.

The softening composition described herein is characterized by a stable viscosity below about 500 cps and more preferably below about 250 cps such that it remains easily pourable over a wide range of ambient temperatures and for extended periods of time.

In the fatty ester quaternary ammonium compound of the invention, the weight normalized percentage of monoester compound is preferably from about 31% to about 37%, the weight normalized percentage of diester compound is preferably from about 53% to about 59%, and the weight normalized percentage of triester compound is preferably from about 8% to about 12%.

This invention also encompasses a method for softening fabrics comprising rinsing the fabrics to be treated in an aqueous bath containing an effective amount of a composition comprised of the above-defined fabric softening composition.

The percentage, by weight, of mono, di, and tri esterquats, as described herein, is determined by the quantitative analytical method described in the publication “Characterisation of quaternized triethanolamine esters (esterquats) by HPLC, HRCGC and NMR” A. J. Wilkes, C. Jacobs, G. Walraven and J. M. Talbot—Colgate Palmolive R&D Inc.—4th world Surfactants Congress, Barcelone, 3-7 VI 1996, page 382. The percentages, by weight, of the mono, di and tri esterquats measured on dried samples are normalized on the basis of 100%. The normalization is required due to the presence of about 10% to 15%, by weight, of non-quaternized species, such as ester amines and free fatty acids. Accordingly, the normalized weight percentages described herein refer to the pure esterquat component of the raw material.

The present invention is predicated on the discovery that the use of the fatty ester quaternary ammonium compound of the invention at concentrations of from 10 to 25%, by weight, in a softening composition in the presence of an electrolyte results in a significantly greater dispersion of the esterquat compound in the aqueous softener composition relative to the use of conventional esterquat compounds such that the need for an emulsifying agent or other additive or special homogenization processing or equipment of the aqueous composition to provide dispersibility is as a general rule no longer necessary. This improved dispersibility is reflected in the formation of softener compositions manifesting significantly improved physical stability and which are characterized by viscosity below 500 cps and preferably 250 cps which remains stable such that the compositions remain easily pourable at elevated concentrations and over a wide range of ambient temperature and for extended periods of time. Moreover, the composition of the present invention provide equivalent softness performance relative to compositions containing equivalent levels of conventional esterquat softener.

### DETAILED DESCRIPTION OF THE INVENTION

The esterquat fabric softeners of the invention are prepared by quaternizing the product of the condensation reaction between fatty acid and an alkanol amine as described in U.S. Pat. No. 3,915,867, the disclosure of which is incorporated herein by reference. The resulting esterification product is an esterquat compound containing three esterquat species: mono-esterquat; di-esterquat; and tri-esterquat respectively, resulting from the reaction of one, two and three fatty acid molecules on one trialkanolamine molecule.

Depending on the esterification process conditions, the distribution of these three species may vary. The esterquat compounds described herein are prepared by quaternizing the product of the condensation reaction between a fatty acid fraction containing at least one saturated or unsaturated linear or branched fatty acid, or derivative, and at least one functionalized tertiary amine, wherein the molar ratio of the fatty acid fraction to tertiary amine is from about 1.7:1. The method of manufacture for such a esterquat surfactant is described in U.S. Pat. No. 5,637,743 (Stepan), the disclosure of which is incorporated herein by reference.

The aforementioned molar ratio will determine the equilibrium between the mono, di and tri-esterquat compounds in the products. For example, using a molar ratio of about 1.7 results in a normalized distribution of about 34% mono-esterquat, about 56% of di-esterquat and about 10% of tri-esterquat which is a fatty ester quat compound in accordance with the invention. On the other hand, for example, using a molar ratio of about 1.96 results in a normalized distribution of about 21% mono-esterquat, 61% of di-esterquat and 18% of tri-esterquat. The latter esterquat compound having such an equilibrium distribution is not in accordance with the present invention and is described herein in the Examples as a comparative composition representative of the prior art.

The present softener compositions are provided as aqueous dispersions in which the fabric softener esterquat compounds are present in finely divided form stably dispersed in the aqueous phase. Generally, particle sizes of the dispersed particles of less than about 25 microns (μm), preferably less than 20 μm, especially preferably no more than 10 μm, on average are acceptable for both softening and stability insofar as the particle sizes can be maintained during actual use, typically in the rinse cycle of an automatic laundry washing machine. The lower limit is not particularly critical but from a practical manufacturing standpoint will not generally be below about 0.01 μm, preferably at least about 0.05 μm. A preferred particle size range of the dispersed softener ingredients is from about 0.1 to about 8 μm.

The aqueous phase of the dispersion is primarily water, usually deionized or distilled water. Small amounts (e.g. up to about 5% by weight) of co-solvent may be present if needed for adjustment of viscosity. The preferred alcohols are those having from 2 to 4 carbon atoms, such as, for example, ethanol, propanol, isopropanol, and propylene glycol or ethylene glycol. Isopropyl alcohol (2-propanol) is especially preferred. However, co-solvents are not required and are generally avoided.

The softener compositions of the invention include an electrolyte to reduce the dispersion viscosity and to maintain a stable low viscosity on the order of less than about 500 cps and more preferably 250 cps for long periods of time. Generally, any of the alkaline metals or alkaline earth metal salts of the mineral acids can be used as electrolyte. Based on their availability, solubility and low toxicity, NaCl, CaCl₂, MgCl₂ and MgSO₄ and similar salts of alkaline and alkaline earth metals are preferred, and CaCl₂ is especially preferred. The amount of the electrolyte will be selected to assure that the composition reaches viscosity below 500 cps and more preferably 250 cps. Generally, amounts of electrolyte salt needed are from 0.01% to 1.0 wt %, and preferably from 0.01 to 0.40 wt %.

Unlike concentrated softener compositions of the prior art, the compositions of the invention do not generally require an emulsifier to disperse the softening ingredient(s) in the composition and to insure the physical stability of the composition. Optionally, an emulsifier may be included in the softener composition, such as, a fatty alcohol ethoxylate having an alkyl chain length from about 13 to 15 carbon atoms and wherein the number of ethylene groups is from about 15 to 20 per mole. Especially preferred for such use is Synperonic A20 manufactured by ICI Chemicals, a nonionic surfactant which is an ethoxylated C₁₃-C₁₅ fatty alcohol with 20 moles of ethylene oxide per mole of alcohol.

The compositions of the invention may contain from 0% to about 5% of perfume. As used herein, the term “perfume” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced odoriferous substances. Typically, perfumes are complex mixtures of blends of various organic compounds such as alcohols, aldehydes, ethers, aromatic compounds and varying amounts of essential oils (e.g., terpenes), the essential oils themselves being volatile odoriferous compounds and also serving to dissovle the other components of the perfume.

In the present invention, the particular composition of the perfume is of no importance with regard to the performance of the liquid fabric softener composition so long as it meets the criteria of water immiscibility and having a pleasing odor.

The compositions of the invention may contain from 0% to about 2% of a preservative agent such as solutions of lactic acid or formaldehyde or dispersion of 1,2-dibromo-2,4-dicyanobutane mixed with bromonitro propanediol (Euxyl K446 from Schulke & Mayr) or dispersion of 1.2-benzisothiazolin-3-one molecule (Proxel BD2 or GXL from Avecia Biocides).

To prevent gelation of super-concentrated liquid compositions, the compositions may contain a polyethylene glycol polymer or polyethylene glycol alkyl ether polymer. The polyethylene glycol polymers useful herein have a molecular weight of at least 200 up to a molecular weight of about 8,000. Useful polymers include the polyethylene glycol and polyethylene glycol methyl ether polymers marketed by Aldrich Chemical Company. Useful amounts of polymer in the composition range from about 0.1% to about 5%, by weight. A range of from about 0.5 to about 1.5%, by weight, is preferred.

Another additive which has been found to be useful as a rheology modifier is citric acid, generally in amounts of from about 0.05 to 1.0 wt %, preferably from about 0.1 to 0.6 weight percent.

A co-softener may optionally be included in the present composition such as example fatty alcohol, glycerol mono-stearate or glycerol mono-oleate.

Other optional components commonly used in fabric softening compositions may be added in minor amounts to enhance either the appearance or performance properties of the liquid fabric softener compositions of this invention. Typical components of this type include, but are not limited to colorants, e.g., dyes or pigments, bluing agents and germicides.

The fabric softener composition, whether in concentrated or diluted form must be easily pourable by the end user. Generally, therefore, product viscosity when used by the consumers should not exceed about 500 centipoise, preferably not more than 250 centipoise. As used herein, unless otherwise specified, viscosity is measured at 25° C. (22-26° C.) using a Brookfield RVTD Digital Viscometer with Spindle #2 at 50 rpm.

The concentrated compositions may be diluted by a factor of generally 4:1 or more, preferably up to about 8:1 or even 10:1. Concentrated products with up to about 25 weight percent of softeners may be prepared and will remain pourable and stable against phase separation or suspended particle agglomeration for extended periods of time.

A sequestering or chelating compound may optionally be included in the fabric softening compositions of the invention at a concentration of from 0% to 2%, by weight. The useful sequestering compounds are capable of sequestering metal ions and are present at a level of at least 0.001%, by weight, of the softening composition, preferably from about 0.001% (10 ppm) to 0.5%, and more preferably from about 0.005% to 0.25%, by weight. The sequestering compounds which are acidic in nature may be present either in the acidic form or as a complex/salt with a suitable counter cation such as an alkali or alkaline earth metal ion, ammonium or substituted ammonium ion or any mixtures thereof.

The sequestering compounds are selected from among amino carboxylic acid compounds and organo aminophosphonic acid compounds, and mixtures of same. Suitable amino carboxylic acid compounds include: ethylenediamine tetraacetic acid (EDTA); N-hydroxyethylenediamine triacetic acid; nitrilotriacetic acid (NTA); and diethylenetriamine pentaacetic acid (DEPTA).

Suitable organo aminophosphonic acid compounds include: ethylenediamine tetrakis (methylenephosphonic acid); 1-hydroxyethane 1,1-diphosphonic acid (HEDP); and aminotri (methylenephosphonic acid).

### EXAMPLE 1

The present example demonstrates the advantage provided by the compositions of the invention in the formulation of concentrated fabric softener compositions versus corresponding compositions comprising a conventional esterquat which is outside the present invention.

As used in this Example and in Tables 1 and 2, Esterquat A refers to an esterquat outside of the present invention which is characterized by a distribution of about 21% monoester, about 61% diester and about 18% triester compounds (normalized % by weight on dried samples).

Esterquat B refers to an esterquat in accordance with the invention which is characterized by a distribution of about 34% monoester, about 56% diester and about 10% triester compounds (normalized % by weight on dried samples).

Softening compositions containing Esterquat A are provided herein as comparative compositions, relative to softening compositions of the invention which contain Esterquat B.

Softenening compositions containing from 16 to 27.5% of esterquat (A or B and at 90% active in isopropanol) are described in Table 1 and were prepared as follows:

Warm water at approximately 60° C. was introduced into a mixer along with the sequestering agent with stirring followed by the addition of esterquat at approximately 60° C. The perfume and the CaCl2 were added to the hot emulsion and the mixture then cooled to 30° C. The dye and the preservative were then added as the final step. Viscosity measurement of the compositions are shown in Table 1 below.

TABLE 1

| | Formulations % w/w | | | | | |
|---|---|---|---|---|---|---|
| | 1 | 2 | 3 | 4 | 5 | 6 |
| Water | qs | qs | qs | qs | qs | qs |
| Esterquat A* | 16.5 | 22 | 27.5 | 0 | 0 | 0 |
| (90% | | | | | | |
| active in | | | | | | |
| isopropanol) | | | | | | |
| Esterquat | 0 | 0 | 0 | 16.5 | 22 | 27.5 |
| B** (90% | | | | | | |
| active in | | | | | | |
| isopropanol) | | | | | | |
| Emulsifier | 0 | 0 | 0 | 0 | 0 | 0 |
| agent | | | | | | |
| CaCl2 | 0.25 | 0.25 | 0.25 | 0.25 | 0.25 | 0.25 |
| Fragrance | 1.7 | 1.7 | 1.7 | 1.7 | 1.7 | 1.7 |
| Sequestring | 0.1 | 0.1 | 0.1 | 0.1 | 0.1 | 0.1 |
| agent | | | | | | |
| Preservative: | 0.05 | 0.05 | 0.05 | 0.05 | 0.05 | 0.05 |
| Proxel | | | | | | |
| (Avecia | | | | | | |
| Biocides) | | | | | | |
| dye | | | | | | |
| Viscosity | 724 | >1000 | >1000 | 46 | 156 | 116 |
| 25° C. | | | | | | |
| after making | | | | | | |
| Viscosity | 745 | >1000 | >1000 | 33 | 70 | 55 |
| 25° C. | | | | | | |
| after 1 day | | | | | | |

The viscosity of Compositions 1-6 were measured “after making” (t=0) and after one day. Compositions 4, 5 and 6 of the invention were characterized by viscosities after one day which varied from about 30 to 70 cps, while corresponding comparative compositions 1, 2 and 3 were characterized by very high viscosities or formed a gel. Accordingly, the compositions of the invention formed products having a desirable low viscosity of below 200 cps and which viscosity remained stable after 24 hours, unlike the comparative compositions.

### EXAMPLE 2

In this Example, Compositions 7, 8, 9 and 10 shown in Table 2 represent comparative softening compositions containing 11% and 16.5% of Esterquat A, both with and without an emulsifier, respectively. Softening compositions 11, 12 and 13 are compositions of the invention containing Esterquat B, and all were formulated without an emulsifier. As noted, in Table 2, the comparative compositions formulated without emulsifier resulted in either a high viscosity product which was unstable or a gelled product while the comparative compositions which contained an emulsifier had a more stable viscosity profile but nevertheless varied sharply in viscosity when Composition 10 containing an elevated concentration of 16.5% esterquat was aged at 4° C. and 43° C. In contrast thereto, Compositions of the invention 11, 12 and 13 all manifested a low and stable viscosity profile over a wide range of temperature and a wide range of concentration. It is noteworthy that all the compositions of the invention were formulated without an emulsifier and yet remained stable over the temperature range of 4° C. to 43° C. during the 4 weeks of aging.

TABLE 2

| | Formulations % w/w | | | | | | |
|---|---|---|---|---|---|---|---|
| | 7 | 8 | 9 | 10 | 11 | 12 | 13 |
| Water | qs | qs | qs | qs | qs | qs | qs |
| Esterquat A* (90% active in isopropanol) | 11 | 11 | 16.5 | 16.5 | 0 | 0 | 0 |
| Esterquat B** (90% active in isopropanol) | 0 | 0 | 0 | 0 | 11 | 16.5 | 22 |
| Emulsifier agent | 0 | 0.25 | 0 | 0.25 | 0 | 0 | 0 |
| CaCl2 | 0.25 | 0.25 | 0.25 | 0.25 | 0.25 | 0.25 | 0.25 |
| Fragrance | 1.7 | 1.7 | 1.7 | 1.7 | 1.7 | 1.7 | 1.7 |
| Sequestring agent | 0.1 | 0.1 | 0.1 | 0.1 | 0.1 | 0.1 | 0.1 |
| Preservative: lactic acid | 0.063 | 0.063 | 0.063 | 0.063 | 0.063 | 0.063 | 0.063 |
| dye | | | | | | | |
| Viscosity 25° C. after making | 44 | 80 | 724 | 230 | 21 | 46 | 156 |
| Viscosity 25° C. after 1 day | 73 | 85 | 745 | 190 | 22 | 33 | 70 |
| Viscosity 25° C. after 4 weeks at 4° C. | 260 | 42 | 472 | 108 | 20 | 29 | 36 |
| Viscosity 25° C. after 4 weeks at 25° C. | 250 | 40 | 660 | 102 | 18 | 27 | 34 |
| Viscosity 25° C. after 4 weeks at 35° C. | 300 | 42 | 740 | 160 | 18 | 26 | 32 |
| Viscosity 25° C. after 4 weeks at 43° C. | 425 | 42 | >1000 | 192 | 17 | 25 | 33 |

What is claimed is:

1. A concentrated dispersible aqueous rinse cycle fabric softening composition which remains physically stable and which is characterized by a stable viscosity below about 500 cps such that it remains easily pourable over a wide range of ambient temperatures and for extended periods of time comprising:
(a) from about 10% to about 25% by weight, of a biodegradable fatty ester quaternary ammonium compound derived from the reaction of an alkanol amine and a fatty acid derivative followed by quaternization, said fatty ester quaternary ammonium compound being represented by the formula: 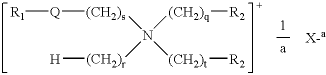
wherein Q represents a carboxyl group having the structure —OCO— or —COO—; R1 represents an aliphatic hydrocarbon group having from 8 to 22 carbon atoms; R2 represents —Q-R1 or —OH; q, r, s and t, each independently represent a number of from 1 to 3; and X^{-a} is an anion of valence a; and
wherein said fatty ester quaternary ammonium compound is comprised of a distribution of monoester, diester and triester compounds, the monoesterquat compound being formed when each R₂ is —OH; the diesterquat compound being formed when one R₂ is —OH and the other R₂ is —Q-R1; and the triesterquat compound being formed when each R₂ is —Q-R1; and wherein the normalized percentage of monoesterquat compound in said fatty ester quaternary ammonium compound is from 28% to 39%; the normalized percentage of diesterquat compound is from 52% to 62% and the normalized percentage of triesterquat compound is from 7% to 14%; all percentages being by weight;
(b) from about 0.01% to about 1%, by weight, of an electrolyte; and
(c) from about 0% to about 2%, by weight, of a sequestering agent;
(d) from about 0% to about 2%, by weight, of an emulsifier;
(e) from about 0% to about 5%, by weight, of a perfume; and
(f) balance water.

2. A fabric softening composition in accordance with claim 1 wherein the viscosity remains below about 250 cps over a wide range of ambient temperatures and for extended periods of time.

3. A fabric softening composition in accordance with claim 1 wherein the normalized percentage of monoester compound in said fatty ester quaternary ammonium compound is from about 31% to about 37%; the normalized percentage of diester compound is from about 53% to about 59%, and the normalized percentage of triester compound is from about 8% to about 12%, all percentages being by weight.

4. A fabric softening composition in accordance with claim 2 wherein the normalized percentage of monoester compound is about 34%; the normalized percentage of diester compound is about 56% and the normalized percentage of triester compound is about 10%.

5. A fabric softening composition in accordance with claim 2 which contains 1.2-benzisothiazolin-3-one molecule (Proxel tradename from Avecia Biocides) as preservative agent.

6. A method for softening fabrics comprising forming an aqueous solution containing an effective amount of the fabric softening composition of claim 1, and then contacting the fabrics to be softened with said aqueous solution.
